(19) United States
(12) Patent Application Publication
(10) Pub. No.: US 2025/0137546 A1
(43) Pub. Date: May 1, 2025

(54) Magnetic Latching Valve with an Enhanced Exhaust Configuration

(71) Applicant: IMI PLC, Federal Way, WA (US)

(72) Inventors: Jonathan Glenn Walp, Federal Way, WA (US); Tushar Prakash Honrao, Federal Way, WA (US); Bárbara Fabiola Álvarez Palomino, Federal Way, WA (US); Xin Xin, Federal Way, WA (US)

(21) Appl. No.: 18/910,078

(22) Filed: Oct. 9, 2024

Related U.S. Application Data
(60) Provisional application No. 63/594,469, filed on Oct. 31, 2023.

(51) Int. Cl. F16K 31/06

(52) U.S. Cl. CPC F16K 31/0658; F16K 31/0675

(57) ABSTRACT

An example valve includes: a plurality of ports including an inlet port, an outlet port, and an exhaust port; a solenoid coil having a cavity; an armature movable in the cavity of the solenoid coil; a retainer mounted at the exhaust port; and a seal mounted to the retainer, wherein as a signal having a particular polarity energizes the solenoid coil, a solenoid force is applied to the armature, causing the armature to move axially in the proximal direction to a particular position, allowing fluid flow from the outlet port, through the retainer, expanding the seal to allow fluid to flow around the seal to be vented to an external environment, while preventing ingestion of foreign substances.

### CROSS REFERENCE TO RELATED APPLICATION

The present application claims priority to U.S. Provisional Patent Application No. 63/594,469, filed on Oct. 31, 2023, the entire contents of which are herein incorporated by reference as if fully set forth in this description.

### BACKGROUND

In a fluid control system, valves are used to control fluid (e.g., air or gas) flow to and from one or more actuators. An example valve includes a solenoid actuator having a solenoid coil that when energized causes a movable element, such as a spool, to move to direct fluid from a source of fluid to an actuator. Some valves further include a vent or exhaust port that allows fluid to be exhausted to an external environment of the valve.

Conventional valves may have a porous plug disposed at the exhaust port. Such a porous plug is used as a control element that allows gas flow to an external environment of the valve, while preventing reverse flow from the environment to within the valve. However, in some environments, porous plugs might not be capable of or might not be sufficient to prevent ingestion of damaging substances (e.g., water or debris) to within the valve.

As an example for illustration, if the valve is used on vehicles or trucks, a porous plug might not be able to completely prevent water or salt water coming in contact with the valve via tire spray, road splash, or pressure washing from being ingested within the valve. Ingestion of water/salt water may cause corrosion and malfunctioning of the solenoid actuator or other sensitive internal components of the valve.

It may thus be desirable to configure the valve with an exhaust configuration that substantially enhances the ability to prevent ingestion or intrusion of damaging substances via an exhaust port of the valve. It is with respect to these and other considerations that the disclosure made herein is presented.

### SUMMARY

The present disclosure describes implementations that relate to a magnetic latching valve with an enhanced exhaust configuration.

In a first example implementation, the present disclosure describes a valve assembly. The valve assembly includes: a plurality of ports including an inlet port, an outlet port, and an exhaust port; a solenoid coil having a cavity; an armature movable in the cavity of the solenoid coil; a retainer mounted at the exhaust port; and a seal mounted to the retainer, wherein as a signal having a particular polarity energizes the solenoid coil, a solenoid force is applied to the armature, causing the armature to move axially in the proximal direction to a particular position, allowing fluid flow from the outlet port, through the retainer, expanding the seal to allow fluid to flow around the seal to be vented to an external environment. The seal prevents ingestion of debris or foreign substances within the valve assembly.

In a second example implementation, the present disclosure describes a system including the valve assembly of the first example implementation, where the system includes a source of fluid coupled to the inlet port, a fluid consumer coupled to the outlet port, and a controller configured to provide signals to the solenoid coil.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a system comprising a valve assembly, according to an example implementation.

FIG. 2 illustrates a front view of the valve assembly of FIG. 1, according to an example implementation.

FIG. 3 illustrates a cross-sectional side view of the valve assembly of FIG. 1, according to an example implementation.

FIG. 4 illustrates a perspective exploded view of the valve assembly of FIG. 1, according to an example implementation.

FIG. 5 illustrates a partial cross-sectional bottom view of a distal end of the valve assembly, according to an example implementation.

FIG. 6 illustrates a partial cross-sectional bottom view of a proximal end of the valve assembly, according to an example implementation.

FIG. 7 illustrates a perspective view of an assembly of a retainer with a seal thereto mounted, according to an example implementation.

FIG. 8 illustrates a front view of the assembly of FIG. 7, according to an example implementation.

FIG. 9 a cross-sectional side view of the assembly of FIGS. 7-8, according to an example implementation.

FIG. 10 illustrates a perspective cross-sectional view of the assembly of FIGS. 7-9, according to an example implementation.

FIG. 11 illustrates a partial cross-sectional side view of the valve assembly of FIG. 3 showing airflow path through a retainer at an exhaust port of the valve assembly, according to an example implementation.

### DETAILED DESCRIPTION

Disclosed here is a valve assembly with an enhanced exhaust configuration that allows air/gas to be vented from a valve, while substantially enhancing prevention of ingestion or intrusion of damaging substances via an exhaust port of the valve.

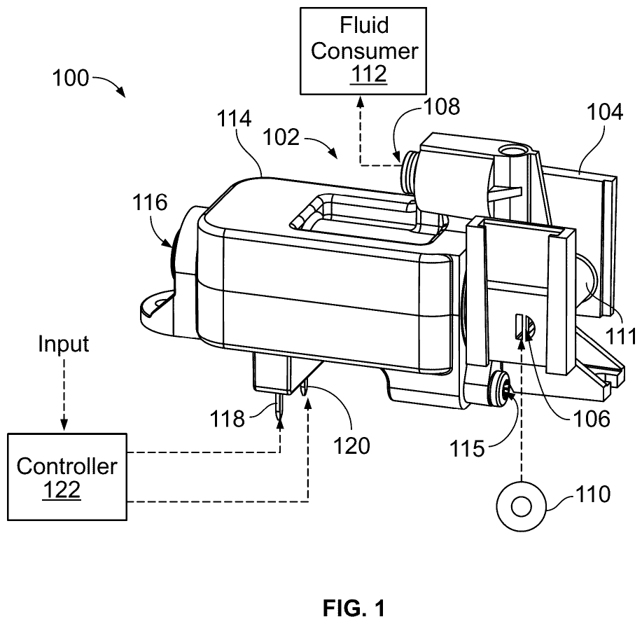

FIG. 1 illustrates a system 100 having a valve assembly 102, according to an example implementation. The valve assembly 102 includes a manifold 104 having a supply or inlet port 106 and an outlet port 108.

The system 100 includes a source 110 of fluid that is fluidly coupled to the inlet port 106 of the manifold 104. The term “fluidly couple” is used throughout herein to indicate that fluid can flow or be communicated between two fluid passages, chambers, ports, or openings.

The source 110 can be a pump, air compressor, an accumulator, or an actuator discharging fluid, as examples. The fluid from the source 110 is communicated via the inlet port 106 through a lateral bore or lateral channel within a cylindrical portion 111 of the manifold 104.

The system 100 further includes a fluid consumer 112. The fluid consumer 112 can, for example, be an actuator (e.g., a pneumatic cylinder) or any other device that operates based on pressurized fluid (e.g., compressed air). In another example, the fluid consumer 112 is a fluid reservoir or tank.

The manifold 104 is coupled to a solenoid coil 114 via fasteners such as screw 115. The solenoid coil 114 is an encapsulated or over-molded coil configured as a valve body or housing that contains other components of the valve assembly 102. The solenoid coil 114 defines a vent or exhaust port 116.

The solenoid coil 114 is electrically-coupled to a terminal 118 and a terminal 120. Electric power provided to the terminals 118, 120 energizes the solenoid coil 114.

The system 100 further a controller 122 that is configured to provide electric signals to the terminals 118, 120 based on input signals (e.g., operator commands or commands from a main controller of a vehicle). In an example, the controller 122 is electrically-coupled to the terminals 118, 120 or a communication bus, e.g., Communication Area Network (CAN) bus, which facilitates transmission of signals between various components of the system 100. The valve assembly 102 controls fluid flow from the source 110 to the fluid consumer 112 based on command signals provided by the controller 122.

The controller 122 is an electronic controller that includes one or more processors or microprocessors and may include data storage (e.g., memory, transitory computer-readable medium, non-transitory computer-readable medium, etc.). The data storage may have stored thereon instructions that, when executed by the one or more processors of the controller 122, cause the controller 122 to perform operations described herein.

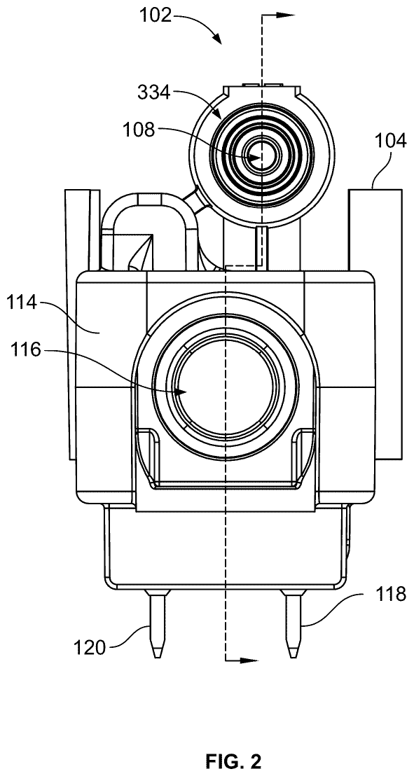

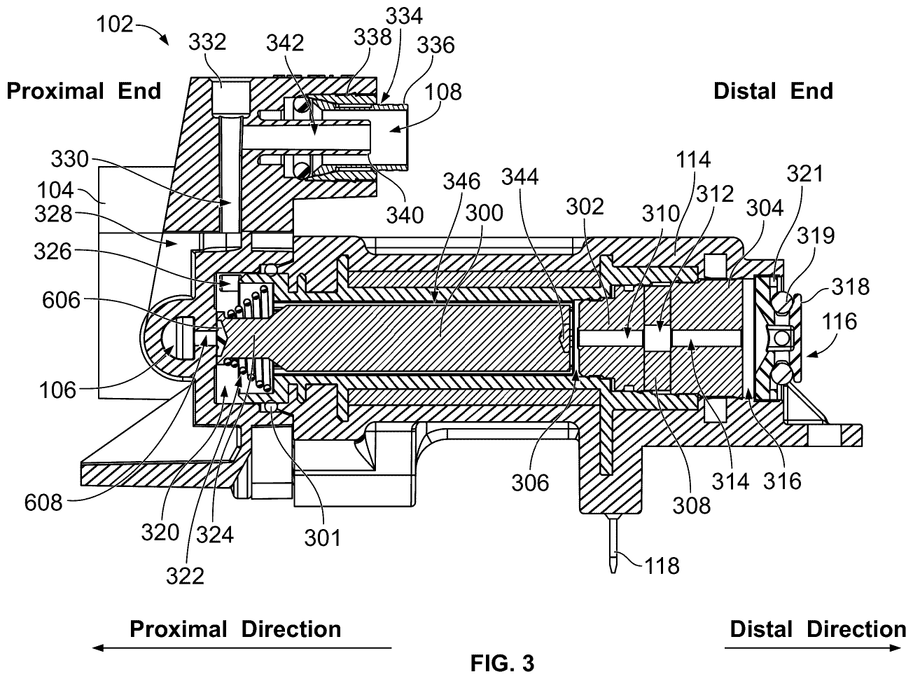

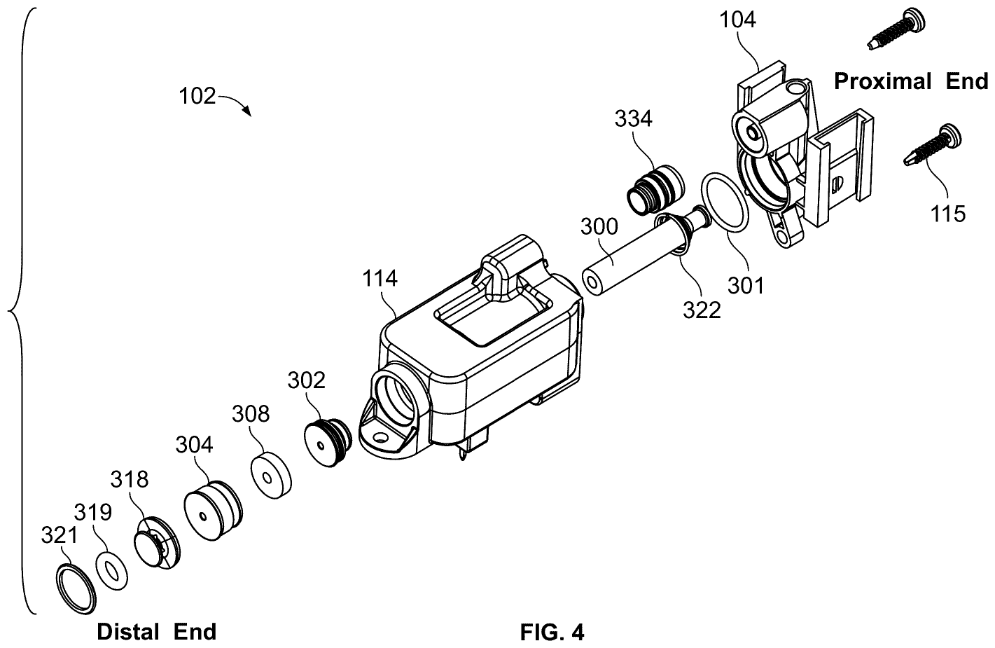

FIG. 2 illustrates a front view of the valve assembly 102, FIG. 3 illustrates a cross-sectional side view of the valve assembly 102, and FIG. 4 illustrates a perspective exploded view of the valve assembly 102, according to an example implementation. FIGS. 2-4 are described together.

As depicted in FIG. 3, the manifold 104 is coupled to the solenoid coil 114, and a seal 301 (e.g., an O-ring) is disposed between the exterior surface of the solenoid coil 114 and the interior surface of the manifold 104. The seal 301 is configured to seal the manifold 104 to the solenoid coil 114 to preclude leakage to an external environment of the valve assembly 102.

The solenoid coil 114 includes a longitudinal cylindrical cavity therein. The valve assembly 102 includes an armature 300 that is slidably accommodated within the longitudinal cylindrical cavity. The term “slidably accommodated” is used herein to indicate that the armature 300 is axially movable within the solenoid coil 114.

The armature 300 can also be referred to as a plunger or spool. The armature 300 operates as an iron core that enhances the magnetic field and the electromagnetic force generated by the solenoid coil 114 when the solenoid coil 114 is energized. Example materials from which the armature 300 can be made include soft iron, manganese, cobalt, a metallic oxide, iron alloy such as manganese zinc ferrites, etc.

The valve assembly 102 further includes a segmented pole piece comprising an inner or proximal pole piece 302 and an outer or distal pole piece 304. Both the proximal pole piece 302 and the distal pole piece 304 are disposed at a distal side of the armature 300. In the state shown in FIG. 3, the armature 300 is separated from the proximal pole piece 302 by an airgap 306.

The pole pieces 302, 304 are made of a material of high magnetic permeability (e.g., ferromagnetic material) and operate as a magnet when an electric current is applied to the windings of the solenoid coil 114. The pole pieces 302, 304 are fixedly disposed within the solenoid coil 114.

FIG. 5 illustrates a partial cross-sectional bottom view of a distal end of the valve assembly 102, according to an example implementation. The pole pieces 302, 304 can be fixedly mounted within the longitudinally cavity of the solenoid coil 114 via different methods. In the example implementation shown in FIG. 5, the pole pieces 302, 304 are barbed, and their barbs allow them to be press-fitted within the solenoid coil 114 and remain secured therein.

Particularly, the distal pole piece 304 can have barb 500 and the proximal pole piece has barb 502 and barb 504. Each of the barbs 500-504 can include one or more continuous ridges or bumps on the respective pole piece, and the barbs 500-504 operate as a grip that securely mounts the pole pieces 302, 304 within the solenoid coil 114. As the pole pieces 302, 304 are inserted into the solenoid coil 114 in a proximal direction, they can be slightly compressed, and then once the pole pieces 302, 304 are in position, they grip the interior surface of the solenoid coil 114 and secure the pole pieces 302, 304 in position. The number, spacing, and configuration of the barbs 500, 502, and 504 depicted in the Figures are an example for illustration, and a different number and spacing of barbs can be used.

Referring back to FIGS. 3-4, the valve assembly 102 further includes a magnet 308 securely interposed between the proximal pole piece 302 and the distal pole piece 304. The magnet 308 is a permanent magnet, i.e., a magnet that retains its magnetism after it is removed from a magnetic field. As an example, the magnet 308 is made of an iron alloy, which in addition to iron, may include aluminum (Al), nickel (Ni), and cobalt (Co). In another example, the magnet 308 is an N40 grade rare-earth magnets such as a neodymium magnet, which is a rare earth permanent magnet made from an alloy of neodymium, iron and boron.

As depicted in the Figures, the magnet 308 is ring-shaped. Further, the magnet 308 is axially-magnetized (as opposed to being diametrically magnetized). In the example implementation described herein, the north pole of the magnet 308 faces or is oriented in the distal direction toward the distal pole piece 304, whereas the south pole of the magnet 308 faces in the proximal direction toward the proximal pole piece 302. As such, the magnet 308 is magnetized through its width or thickness.

With this configuration, the magnet 308 generates a magnetic field that causes a magnetic force to be applied on the armature 300 in the distal direction. The magnitude of the magnetic force applied by the magnet 308 varies with the axial distance between the magnet 308 and the armature 300. Particularly, the magnitude of the magnetic force applied by the magnet 308 on the armature 300 is inversely proportional to the square of the axial distance therebetween.

The proximal pole piece 302 has a channel 310 aligned with a hole 312 of the magnet 308 and a respective channel 314 of the distal pole piece 304. The channel 310, the hole 312, and the channel 314 together form a fluid passage that fluidly couples the airgap 306 to a gap 316 that separates the distal pole piece 304 from a retainer 318.

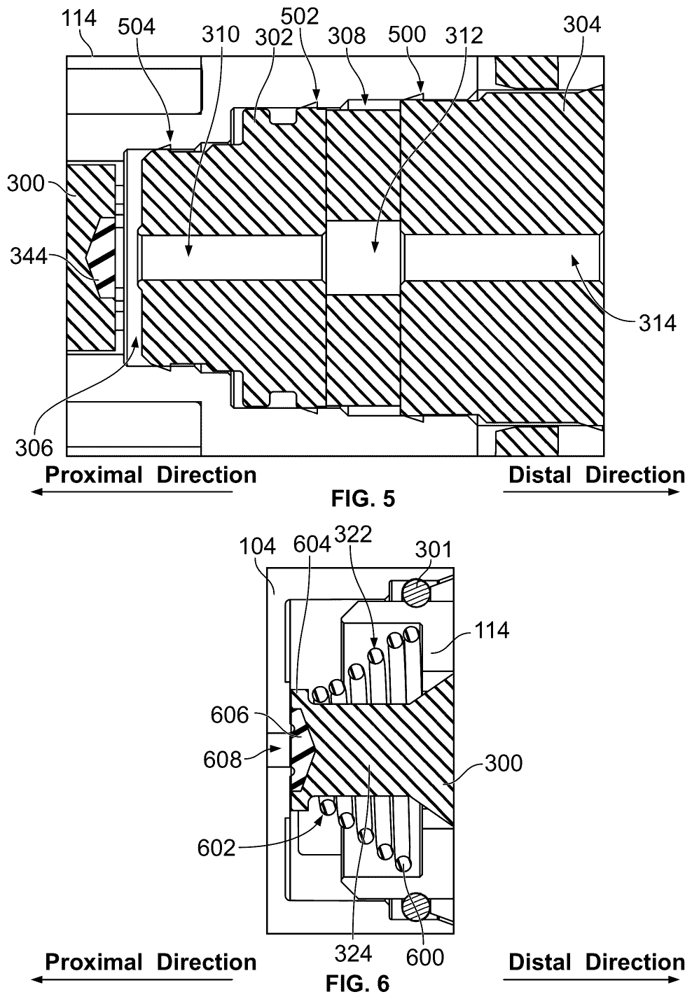

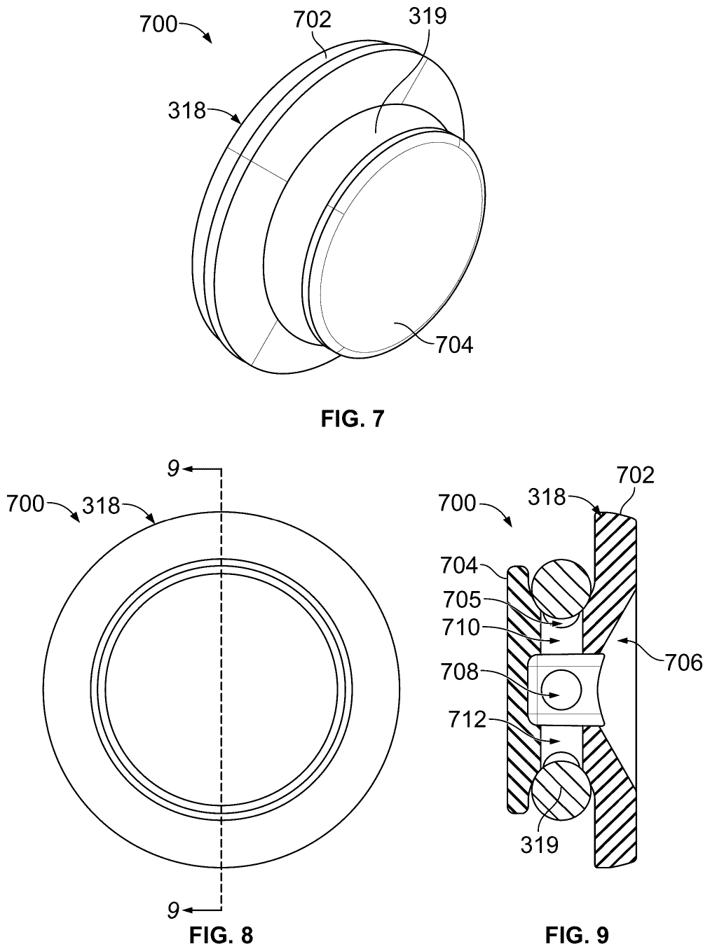

The retainer 318 is used as a control element of gas flow from the gap 316 to the exhaust port 116, which is exposed to an external environment of the valve assembly 102. A seal 319 (e.g., a rubber O-ring) is mounted within a groove formed in the retainer 318. The valve assembly 102 can include a retaining ring 321 to retain the retainer 318 and the seal 319 mounted thereto to the solenoid coil 114. As described below with respect to FIGS. 7-11, the retainer 318 and seal 319 provide an enhanced exhaust configuration that substantially prevents ingestion of foreign substances (e.g., salt water) while allowing air or gas to be exhausted from the valve assembly 102.

As depicted in FIG. 3, an inner chamber 320 is formed between or enclosed by the manifold 104 and the proximal end of the solenoid coil 114. The inner chamber 320 includes a spring 322 disposed about a reduced-diameter portion 324 of the armature 300.

FIG. 6 illustrates a partial cross-sectional bottom view of a proximal end of the valve assembly 102, according to an example implementation. In the example implementation depicted in FIG. 6, the spring 322 is configured as a conical spring that is coiled in increasing outer diameter in the distal direction. In other words, the spring 322 is tapered and has the shape of a cone. With this configuration, the spring 322 can apply a particular spring force at a reduced solid height compared to a non-conical spring, and may provide enhanced stability.

A distal end of the spring 322, and particularly a largest-diameter coil 600 thereof, rests against an interior surface of the solenoid coil 114. On the other hand, a proximal end of the spring 322, and particularly a smallest-diameter coil 602 thereof, rests against an armature flange 604 formed at the proximal end of the armature 300.

As such, the distal end of the spring 322 is fixedly disposed on the interior surface of the solenoid coil 114, whereas the proximal end of the spring 322 rests against the armature flange 604. This way, the spring 322 applies a biasing spring force on the armature 300 in the proximal direction.

As mentioned above, the magnitude of the magnetic force applied by the magnet 308 on the armature 300 in the distal direction varies with the axial distance between the magnet 308 and the armature 300. In the axial position of the armature 300 depicted in FIGS. 3, 5-6, the spring force of the spring 322 acting on the armature 300 in the proximal direction is greater than the magnetic force applied by the magnet 308 on the armature 300. Therefore, the armature 300 is biased in the proximal direction toward the axial position shown in FIGS. 3, 5-6.

As shown in FIG. 6, the armature 300 includes or houses a seal element 606 disposed or enclosed within the proximal end of the armature 300. The seal element 606 can be made of a compressible, flexible material. In the axial position of the armature 300 shown in FIGS. 3 and 6, the seal element 606 is compressed under the biasing force of the spring 322 on the armature 300 to effectively seal a longitudinal channel 608 formed in the manifold 104. The longitudinal channel 608 is fluidly coupled to or in communication with the inlet port 106 via the lateral channel formed in the cylindrical portion 111 of the manifold 104 (see FIG. 1).

Referring to FIG. 3, the manifold 104 includes one or more holes or windows, such as window 326, which fluidly couple the inner chamber 320 to an outer chamber 328 formed within the manifold 104. The manifold 104 further includes a channel 330 that is in fluid communication with the outer chamber 328. A ball 332 can be pressed onto the manifold 104 after a drill is used to drill the channel 330. The ball 332 thus blocks the channel 330 after machining it in the manifold 104. Other blocking means (e.g., a plug) could be used.

As depicted in FIG. 3, the valve assembly 102 can include a fitting or cartridge 334 coupled to the outlet port 108 of the manifold 104. The cartridge 334 facilitates coupling a fluid line (e.g., a tube, hose, or pipe) from the fluid consumer 112 (see FIG. 1) to the outlet port 108, thereby fluidly coupling the valve assembly 102 to the fluid consumer 112.

In an example, the cartridge 334 includes a collet 336 that has the opening associated with the outlet port 108. The collet 336 is configured to be inserted into or “ride on” a sleeve 338 to be coupled thereto. For instance, the collet 336 can be threaded into the sleeve 338, or can have barbs that allow the collet 336 to be press-fitted or interference-fitted to the sleeve 338. The sleeve 338 is coupled to the manifold 104 (e.g., via threads or barbed interference fit). The cartridge 334 further includes a tube support 340 that is configured to be coupled to the fluid line connecting the valve assembly 102 to the fluid consumer 112.

The tube support 340 is hollow and has a channel 342 formed therein. The channel 342 is fluidly coupled to the channel 330 of the manifold 104. With this configuration, the outlet port 108 is fluidly coupled to the inner chamber 320 via the channel 342, the channel 330, the outer chamber 328, and the window 326. The configuration or the cartridge 334 used herein is an example for illustration. Other types of fitting can be used to fluidly couple the outlet port 108 to the fluid consumer 112.

The valve assembly 102 is configured to operate in at least two commanded states based on a polarity of the electric power provided to the solenoid coil 114. The valve assembly 102 operates in a first commanded state when direct current (DC) electric power having a first electric polarity is provided to the solenoid coil 114. For example, DC power or a DC signal with the first electric polarity is provided to the valve assembly 102 when the positive terminal of a power source (e.g., a battery) is connected to the terminal 120 while the negative terminal of the power source is connected to the terminal 118. In other words, the DC signal with the first polarity is provided to the valve assembly 102 when the controller 122 communicates the DC signal to the valve assembly 102 such that the positive voltage of the DC signal is applied to the terminal 120 while the negative voltage is applied or connected to the terminal 118.

When the DC signal with the first polarity is provided through the windings of the solenoid coil 114, a magnetic field is generated. The pole pieces 302, 304 direct the magnetic field through the airgap 306 toward the armature 300, which is movable and is attracted toward the pole pieces 302, 304. In other words, when an electric current with the first polarity is applied to the solenoid coil 114, the generated magnetic field forms a north and south pole in the pole pieces 302, 304 and the armature 300, and therefore the pole pieces 302, 304 and the armature 300 are attracted to each other. Because the pole pieces 302, 304 are fixed while the armature 300 is movable, the armature 300 is attracted to the pole piece 302, 304 and is movable across the airgap 306 toward the pole pieces 302, 304. Thus, when the DC signal with the first polarity is provided to the solenoid coil 114, a solenoid force acting in the distal direction is generated and is applied to the armature 300, thereby attracting the armature 300 toward the pole pieces 302, 304, i.e., the armature 300 is attracted toward the distal direction.

When the solenoid force overcomes the biasing force of the spring 322 and friction forces, the armature 300 moves axially in the distal direction. As the armature 300 moves in the distal direction, the spring 322 is compressed and its biasing force acting in the proximal direction increases. However, as the armature 300 moves in the distal direction, it becomes closer to the magnet 308, and therefore the magnetic force applied by the magnet 308 on the armature 300 in the distal direction increases.

Thus, three forces are acting on the armature 300: (i) the biasing force of the spring 322 acting in the proximal direction, (ii) the electromagnetic force or solenoid force generated by energizing the solenoid coil 114 (with the first polarity DC signal) acting in the distal direction, and (iii) the magnetic force of the magnet 308 acting in the distal direction.

As the armature 300 moves closer to the magnet 308, the combined solenoid and magnetic forces cause the armature 300 to traverse the airgap 306, and distal end face of the armature 300 rests against or contacts the proximal end face of the proximal pole piece 302. Also, as the armature 300 moves closer to the magnet 308 and the magnetic force of the magnet 308 increases, the magnetic force becomes greater than the biasing force of the spring 322. As such, the DC signal to the solenoid coil 114 can be removed, and the armature 300 stays “latched” to the proximal pole piece 302 in a stable position.

With this configuration, the first polarity electric signal from the controller 122 can be applied to the solenoid coil 114 for a particular period of time to move the armature 300 and can then be removed, while the armature 300 remains latched to the proximal pole piece 302 due to the magnetic force of the magnet 308. As an example for illustration, the controller 122 applies a 16 volts (V) DC signal for a period of about 100 milliseconds (ms) to the solenoid coil 114 and the DC signal can then be removed, while the armature 300 remains latched or secured against the proximal pole piece 302. This way, power loss does not affect the commanded state of the valve assembly 102.

As such, the first commanded state achieved when a DC signal with the first polarity is provided to the solenoid coil 114 can be referred to as a “latched state.” In the latched state, the armature 300 is secured against the proximal pole piece 302. As depicted in FIG. 3, the armature 300 includes or houses another seal element 344 within the distal end of the armature 300. Similar to the seal element 606, the seal element 344 can be made of a flexible, compressible material such that when the armature 300 presses against the proximal pole piece 302, the seal element 344 is compressed to effectively seal the channel 310 of the proximal pole piece 302.

On the other hand, the proximal end of the armature 300 disengages from the interior surface of the manifold 104 and the longitudinal channel 608 is exposed (i.e., the seal element 606 no longer seals the longitudinal channel 608). As a result, pressurized fluid provided from the source 110 of fluid to the inlet port 106 flows through the lateral channel in the cylindrical portion 111 of the manifold 104, then flows through the longitudinal channel 608 to the inner chamber 320, then through the window 326 to the outer chamber 328, then through the channel 330 and the channel 342 and through the outlet port 108 to the fluid consumer 112 that is fluidly coupled to the outlet port 108.

As such, in the first commanded state, fluid is allowed to flow from the source 110 to the fluid consumer 112. The valve assembly 102 operates in the first commanded state until a command DC signal with a second polarity (opposite the first polarity) is applied to the solenoid coil 114.

For example, a DC signal with the second polarity is provided to the valve assembly 102 when positive voltage of the DC signal is applied to the terminal 118 while the negative voltage is applied to the terminal 120. When the DC signal with the second polarity is provided through the windings of the solenoid coil 114, the magnetic field generated has an opposite polarity compared to when the DC signal with the first polarity is provided to the solenoid coil 114.

As a result, when the DC signal with the second polarity is provided through the windings of the solenoid coil 114, the solenoid force act on the armature 300 in the proximal direction away from the pole pieces 302, 304. Thus, in the second commanded state, three forces act on the armature 300: (i) the biasing force of the spring 322 acting in the proximal direction, (ii) the electromagnetic force or solenoid force generated by energizing the solenoid coil 114 (with the second polarity DC power) also acting in the proximal direction and is additive to the biasing force of the spring 322, and (iii) the magnetic force of the magnet 308 acting in the distal direction.

The combined spring force of the spring 322 and the solenoid force overcome the magnetic force of the magnet 308, causing the armature 300 to be “unlatched” from the proximal pole piece 302 and move back to the axial position depicted in FIGS. 3 and 5-6. As the armature 300 moves away from the magnet 308, the magnetic force of the magnet 308 decreases and becomes smaller than the biasing force of the spring 322. As such, the DC signal to the solenoid coil 114 can be removed, and the armature 300 stays “unlatched” from the proximal pole piece 302 in a stable position.

With this configuration, the second polarity electric signal from the controller 122 is applied to the solenoid coil 114 for a particular period of time to move the armature 300 back to the unlatched position and is then removed. As an example for illustration, the controller 122 applies a 16 volts (V) DC signal for a period of about 100 ms to the solenoid coil 114 and the signal is then removed, while the armature 300 remains unlatched from the proximal pole piece 302. This way, power loss does not affect the commanded state of the valve assembly 102.

The second commanded state achieved when a DC signal with the second polarity is provided to the solenoid coil 114 can be referred to as an “unlatched state” and is depicted in FIGS. 3, 5-6. In the unlatched state, the proximal end of the armature 300 is secured against the interior surface of the manifold 104.

Particularly, as depicted in FIG. 3, when the armature 300 presses against the interior surface of the manifold 104, the seal element 606 is compressed to effectively seal the longitudinal channel 608 of the manifold 104, thereby blocking fluid flow from the source 110. On the other hand, the distal end of the armature 300 disengages from the proximal pole piece 302 and the channel 310 is exposed (i.e., the seal element 344 no longer seals the channel 310).

As depicted in FIG. 3, the armature 300 includes one or more channels or slots, such as slot 346. For example, the exterior surface of the armature 300 can have ridges formed thereon, with slots like the slot 346 formed between the ridges. As such, fluid from the fluid consumer 112 (e.g., pressurized fluid from the fluid consumer 112 or trapped pressure in the fluid line connecting the outlet port 108 to the fluid consumer 112) is allowed to flow from the fluid consumer to the exhaust port 116.

Particularly, fluid flows from the outlet port 108 through the channel 342 and the channel 330 to the outer chamber 328, then through the window 326 to the inner chamber 320, then through the slot 346 (e.g., between the exterior surface of the armature 300 and the interior surface of the solenoid coil 114) to the airgap 306, then through the channel 310, the hole 312, and the channel 314 to the gap 316. The retainer 318 is configured to allow the fluid to be vented to an external environment of the valve assembly 102 while preventing damaging substances (e.g., water, salt water, debris, etc.) from being ingested into the valve assembly 102.

FIG. 7 illustrates a perspective view of an assembly 700 of the retainer 318 with the seal 319 thereto mounted, FIG. 8 illustrates a front view of the assembly 700, and FIG. 9 illustrates a cross-sectional side view of the assembly 700, according to an example implementation. The cross sectional plane of FIG. 9 is labeled in FIG. 8.

The retainer 318 includes a proximal flange portion 702 (facing the distal pole piece 304) and a distal flange portion 704 (exposed to an external environment of the valve assembly 102). The proximal flange portion 702 is axially spaced from the distal flange portion 704, and a groove 705 is formed therebetween. The seal 319 is mounted in the groove 705 and is axially retained between the flange portions 702, 704. The flange portions 702, 704 are generally cylindrical in shape, with the proximal flange portion 702 having a larger diameter compared to the distal flange portion 704.

Referring to FIG. 9, the proximal flange portion 702 has a conical cavity 706 that directs fluid from the gap 316 to a longitudinal channel 708 formed in the retainer 318. The longitudinal channel 708 is a blind channel as shown in FIG. 9 and extends only partially within the distal flange portion 704.

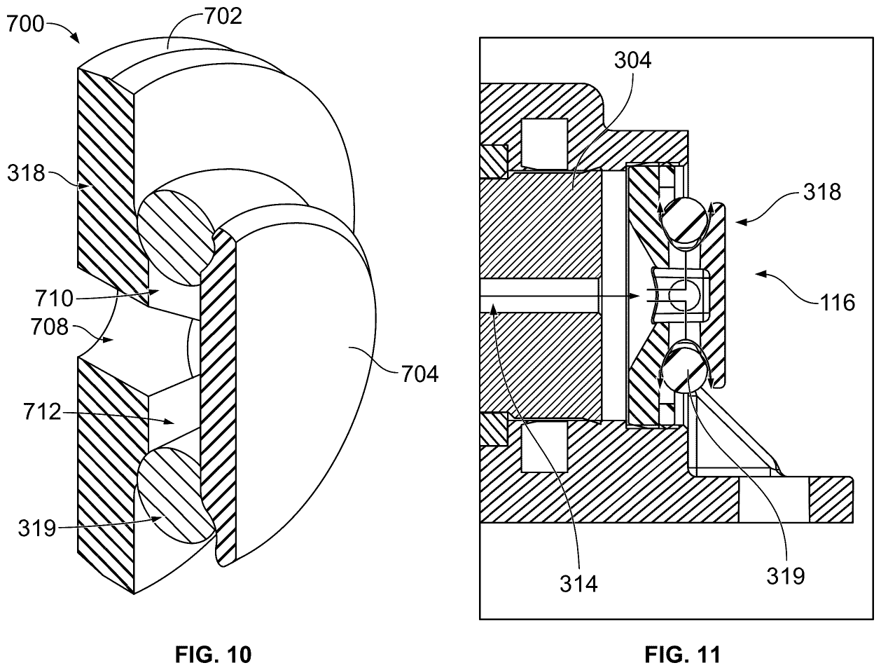

FIG. 10 illustrates a perspective cross-sectional view of the assembly 700, according to an example implementation. Referring to FIGS. 9-10 together, the retainer 318 includes a plurality of lateral or radial holes (e.g., four holes) such as radial hole 710 and radial hole 712 that are fluidly coupled to the longitudinal channel 708. The radial holes 710, 712 extend radially outward to the groove 705 in which the seal 319 is disposed.

FIG. 11 illustrates a partial cross-sectional side view of the valve assembly 102 showing fluid flow path through the retainer 318, according to an example implementation. Particularly, fluid flow through the retainer 318 is represented by arrows in FIG. 11.

Referring to FIGS. 9-11 together, when the valve assembly 102 is in the second commanded state, pressurized air provided to the gap 316 flows through the conical cavity 706, the longitudinal channel 708, then the radial holes 710, 712. Pressurized air then causes the seal 319 to expand, allowing the pressurized air to be vented to the external environment as indicated by the flow arrows. The valve assembly 102 is configured such that, as the air is exhausted to the environment, air pressure level is reduced from a vehicle operating pressure to a threshold low pressure level within a particular period of time. Further, in this state of operation (i.e., during an exhausting state), the pressurized air being vented around the seal 319 prevents water and debris from entering the valve assembly 102. Thus, notably, the valve assembly 102 if capable of lowering pressure level to a desirable threshold value within a particular period of time, while preventing debris and water from enter the valve assembly 102.

When the valve assembly 102 is in the first commanded state, the seal 319 seals against the radial holes 710, 712, preventing water or debris ingestion. Thus, with the configuration of the valve assembly 102, water and debris intrusion into the internal components of the valve assembly 102, thereby preventing rust and malfunctioning of the valve assembly 102.

The sealing configuration at the exhaust port 116 involving the retainer 318 and the seal 319 may provide several advantages. For example, the sealing arrangement can provide full protection of the valve assembly 102 with a rating of Ingress Protection code (IP code) X4 per ISO-20653 Rev2013. The IP code indicates how well a device is protected against water and dust and is defined by the International Electrotechnical Commission (IEC) under the international standard IEC 60529, which classifies and provides a guideline to the degree of protection provided by mechanical casings. The sealing configuration also substantially protects the valve assembly 102 according to rating IPX5, which indicates that ingestion of dust might not entirely be prevented, but dust is not ingest in sufficient quantity to interfere with safe operation of the valve assembly 102. The configuration may also be able to high pressure and steam cleaning according to the IPx9K standard without degradation to structure and functionality.

Further, the sealing arrangement remains affective and functions normally with up to 1.8 inches of ice buildup around the seal 319, for example. Also, the seal 319 is capable of working normally in a temperature range between −40° C. to 85° C. without building too much back pressure (residual pressure in the solenoid coil 114) and without impacting operation of the valve assembly 102.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.
EEE 1 is a valve assembly comprising: a plurality of ports including an inlet port, an outlet port, and an exhaust port; a solenoid coil configured as a housing having a cavity therein; an armature slidably accommodated in the cavity of the solenoid coil; a magnet fixedly disposed within the solenoid coil, wherein the magnet applies a magnetic force on the armature in a distal direction; a spring applying a biasing force on the armature in a proximal direction; a retainer mounted at the exhaust port; and a seal mounted to the retainer, wherein as a signal having a particular polarity energizes the solenoid coil, a solenoid force is applied to the armature in the proximal direction, wherein a combination of the biasing force of the spring and the solenoid force overcome the magnetic force, causing the armature to move axially in the proximal direction to a particular position, thereby blocking fluid flow from the inlet port to the outlet port, while allowing fluid flow from the outlet port, through the retainer, expanding the seal to allow fluid to flow around the seal to be vented to an external environment.
EEE 2 is the valve assembly of EEE 1, wherein the retainer comprises: a groove in which the seal is mounted; a longitudinal channel that is fluidly coupled to the outlet port when the solenoid coil is energized by the signal; and one or more radial holes fluidly coupling the longitudinal channel to the groove, wherein fluid flows from the outlet port through the longitudinal channel, then through the one or more radial holes, expanding the seal and flowing around the seal radially outward to the external environment.
EEE 3 is the valve assembly of EEE 2, wherein the retainer comprises: a proximal flange portion; and a distal flange portion exposed to the external environment, wherein the proximal flange portion is axially spaced from the distal flange portion, and wherein the groove in which the seal is mounted is formed between the proximal flange portion and the distal flange portion such that the seal is axially retained between the proximal flange portion and the distal flange portion.
EEE 4 is the valve assembly of EEE 3, wherein the proximal flange portion and the distal flange portion are generally cylindrical in shape, and wherein the proximal flange portion has a larger diameter compared to the distal flange portion.
EEE 5 is the valve assembly of any of EEEs 3-4, wherein the proximal flange portion has a conical cavity that directs fluid received via the outlet port to the longitudinal channel.
EEE 6 is the valve assembly of any of EEEs 3-5, wherein the longitudinal channel is a blind channel that extends only partially within the distal flange portion.
EEE 7 is the valve assembly of any of EEEs 1-6, further comprising: a proximal pole piece having a channel therein; and a distal pole piece having a respective channel therein, wherein the proximal pole piece and the distal pole piece are fixedly disposed within the solenoid coil, wherein the magnet is interposed between the proximal pole piece and the distal pole piece, and wherein the magnet is ring-shaped and includes a hole that is aligned with the channel and the respective channel.
EEE 8 is the valve assembly of EEE 7, wherein the hole of the magnet, the channel of the proximal pole piece, and the respective channel of the distal pole piece form a fluid passage that fluidly couples an airgap formed between the armature and the proximal pole piece to a gap that separates the distal pole piece from the retainer disposed at the exhaust port.
EEE 9 is the valve assembly of EEE 8, wherein the retainer comprises: a groove in which the seal is mounted; a longitudinal channel; a conical cavity that directs fluid received from the outlet port through the fluid passage and the gap to the longitudinal channel; and one or more radial holes fluidly coupling the longitudinal channel to the groove, wherein fluid flows through the one or more radial holes, expanding the seal and flowing around the seal radially outward to the external environment.
EEE 10 is the valve assembly of any of EEEs 8-9, wherein the armature comprises one or more slots that allow fluid flow from the outlet port to the airgap.
EEE 11 is the valve assembly of any of EEEs 8-10, wherein the magnet is axially-magnetized such that a north pole of the magnet is oriented in the distal direction toward the distal pole piece.
EEE 12 is the valve assembly of any of EEEs 1-11, further comprising: a manifold, wherein

the manifold includes the inlet port and the outlet port, wherein the solenoid coil is coupled to the manifold, and wherein the solenoid coil includes the exhaust port.
EEE 13 is the valve assembly of EEE 12, wherein the armature comprises a seal element within a proximal end of the armature, wherein the seal element is made of a flexible material such that when the armature is in the particular position, the seal element is compressed against an interior surface of the manifold and seals a channel that is fluidly coupled to the inlet port.
EEE 14 is the valve assembly of any of EEEs 1-13, wherein the spring is a conical spring having a largest-diameter coil resting against and an interior surface of the solenoid coil and a smallest-diameter coil resting against a flange formed at a proximal end of the armature.
EEE 15 is the valve assembly of any of EEEs 1-14, wherein when the armature is in the particular position, the magnetic force of the magnet is smaller than the biasing force, and the armature remains in the particular position upon removal of the signal.
EEE 16 is the valve assembly of any of EEEs 1-15, wherein fluid expanding the seal and flowing around the seal to be vented to the external environment prevents ingestion of a foreign substance.
EEE 17 is the valve assembly of any of EEEs 1-16, wherein the signal is a first signal, the particular polarity is a first polarity, the particular position is a first position, wherein as a second signal having a second polarity, opposite the first polarity, energizes the solenoid coil, a respective solenoid force is applied to the armature in the distal direction, wherein a combination of the magnetic force and the respective solenoid force overcome the biasing force of the spring, causing the armature to move axially in the distal direction to a second position, thereby allowing fluid flow from the inlet port to the outlet port, while blocking fluid flow from the outlet port to the exhaust port.
EEE 18 is the valve assembly of EEE 17, wherein the seal is secured to the retainer, preventing ingestion of a foreign substance.
EEE 19 is the valve assembly of any of EEEs 17-18, wherein when the armature is in the second position, the magnetic force of the magnet is greater than the biasing force of the spring, and the armature remains in the second position upon removal of the second signal.
EEE 20 is the valve assembly of any of EEEs 17-19, further comprising: a proximal pole piece having a channel therein; and a distal pole piece having a respective channel therein, wherein the proximal pole piece and the distal pole piece are fixedly disposed within the solenoid coil, wherein the magnet is interposed between the proximal pole piece and the distal pole piece, wherein the magnet is ring-shaped and includes a hole that is aligned with the channel and the respective channel, wherein the hole of the magnet, the channel of the proximal pole piece, and the respective channel of the distal pole piece form a fluid passage that fluidly couples an airgap formed between the armature and the proximal pole piece to a gap that separates the distal pole piece from the retainer disposed at the exhaust port, wherein the armature comprises a seal element within a distal end of the armature, wherein the seal element is made of a flexible material such that when the armature is in the second position, the seal element is compressed against the proximal pole piece and seals the channel of the proximal pole piece, thereby blocking the fluid passage.

What is claimed is:

1. A valve assembly comprising:
a plurality of ports including an inlet port, an outlet port, and an exhaust port;
a solenoid coil configured as a housing having a cavity therein;
an armature slidably accommodated in the cavity of the solenoid coil;
a magnet fixedly disposed within the solenoid coil, wherein the magnet applies a magnetic force on the armature in a distal direction;
a spring applying a biasing force on the armature in a proximal direction;
a retainer mounted at the exhaust port; and
a seal mounted to the retainer, wherein as a signal having a particular polarity energizes the solenoid coil, a solenoid force is applied to the armature in the proximal direction, wherein a combination of the biasing force of the spring and the solenoid force overcome the magnetic force, causing the armature to move axially in the proximal direction to a particular position, thereby blocking fluid flow from the inlet port to the outlet port, while allowing fluid flow from the outlet port, through the retainer, expanding the seal to allow fluid to flow around the seal to be vented to an external environment.

2. The valve assembly of claim 1, wherein the retainer comprises:
a groove in which the seal is mounted;
a longitudinal channel that is fluidly coupled to the outlet port when the solenoid coil is energized by the signal; and
one or more radial holes fluidly coupling the longitudinal channel to the groove, wherein fluid flows from the outlet port through the longitudinal channel, then through the one or more radial holes, expanding the seal and flowing around the seal radially outward to the external environment.

3. The valve assembly of claim 2, wherein the retainer comprises:
a proximal flange portion; and
a distal flange portion exposed to the external environment, wherein the proximal flange portion is axially spaced from the distal flange portion, and wherein the groove in which the seal is mounted is formed between the proximal flange portion and the distal flange portion such that the seal is axially retained between the proximal flange portion and the distal flange portion.

4. The valve assembly of claim 3, wherein the proximal flange portion and the distal flange portion are generally cylindrical in shape, and wherein the proximal flange portion has a larger diameter compared to the distal flange portion.

5. The valve assembly of claim 3, wherein the proximal flange portion has a conical cavity that directs fluid received via the outlet port to the longitudinal channel.

6. The valve assembly of claim 3, wherein the longitudinal channel is a blind channel that extends only partially within the distal flange portion.

7. The valve assembly of claim 1, further comprising:
a proximal pole piece having a channel therein; and
a distal pole piece having a respective channel therein, wherein the proximal pole piece and the distal pole piece are fixedly disposed within the solenoid coil, wherein the magnet is interposed between the proximal pole piece and the distal pole piece, and wherein the magnet is ring-shaped and includes a hole that is aligned with the channel and the respective channel.

8. The valve assembly of claim 7, wherein the hole of the magnet, the channel of the proximal pole piece, and the respective channel of the distal pole piece form a fluid passage that fluidly couples an airgap formed between the armature and the proximal pole piece to a gap that separates the distal pole piece from the retainer disposed at the exhaust port.

9. The valve assembly of claim 8, wherein the retainer comprises:
a groove in which the seal is mounted;
a longitudinal channel;
a conical cavity that directs fluid received from the outlet port through the fluid passage and the gap to the longitudinal channel; and
one or more radial holes fluidly coupling the longitudinal channel to the groove, wherein fluid flows through the one or more radial holes, expanding the seal and flowing around the seal radially outward to the external environment.

10. The valve assembly of claim 8, wherein the armature comprises one or more slots that allow fluid flow from the outlet port to the airgap.

11. The valve assembly of claim 8, wherein the magnet is axially-magnetized such that a north pole of the magnet is oriented in the distal direction toward the distal pole piece.

12. The valve assembly of claim 1, further comprising:
a manifold, wherein the manifold includes the inlet port and the outlet port, wherein the solenoid coil is coupled to the manifold, and wherein the solenoid coil includes the exhaust port.

13. The valve assembly of claim 12, wherein the armature comprises a seal element within a proximal end of the armature, wherein the seal element is made of a flexible material such that when the armature is in the particular position, the seal element is compressed against an interior surface of the manifold and seals a channel that is fluidly coupled to the inlet port.

14. The valve assembly of claim 1, wherein the spring is a conical spring having a largest-diameter coil resting against and an interior surface of the solenoid coil and a smallest-diameter coil resting against a flange formed at a proximal end of the armature.

15. The valve assembly of claim 1, wherein when the armature is in the particular position, the magnetic force of the magnet is smaller than the biasing force, and the armature remains in the particular position upon removal of the signal.

16. The valve assembly of claim 1, wherein fluid expanding the seal and flowing around the seal to be vented to the external environment prevents ingestion of a foreign substance.

17. The valve assembly of claim 1, wherein the signal is a first signal, the particular polarity is a first polarity, the particular position is a first position, wherein as a second signal having a second polarity, opposite the first polarity, energizes the solenoid coil, a respective solenoid force is applied to the armature in the distal direction, wherein a combination of the magnetic force and the respective solenoid force overcome the biasing force of the spring, causing the armature to move axially in the distal direction to a second position, thereby allowing fluid flow from the inlet port to the outlet port, while blocking fluid flow from the outlet port to the exhaust port.

18. The valve assembly of claim 17, wherein the seal is secured to the retainer, preventing ingestion of a foreign substance.

19. The valve assembly of claim 17, wherein when the armature is in the second position, the magnetic force of the magnet is greater than the biasing force of the spring, and the armature remains in the second position upon removal of the second signal.

20. The valve assembly of claim 17, further comprising:
a proximal pole piece having a channel therein; and
a distal pole piece having a respective channel therein, wherein the proximal pole piece and the distal pole piece are fixedly disposed within the solenoid coil, wherein the magnet is interposed between the proximal pole piece and the distal pole piece, wherein the magnet is ring-shaped and includes a hole that is aligned with the channel and the respective channel, wherein the hole of the magnet, the channel of the proximal pole piece, and the respective channel of the distal pole piece form a fluid passage that fluidly couples an airgap formed between the armature and the proximal pole piece to a gap that separates the distal pole piece from the retainer disposed at the exhaust port, wherein the armature comprises a seal element within a distal end of the armature, wherein the seal element is made of a flexible material such that when the armature is in the second position, the seal element is compressed against the proximal pole piece and seals the channel of the proximal pole piece, thereby blocking the fluid passage.
